(19) United States
(12) Patent Application Publication
(10) Pub. No.: US 2004/0103210 A1
(43) Pub. Date: May 27, 2004

(54) Network management apparatus

(76) Inventors: Yasuki Fujii, Kawasaki (JP); Keiji Miyazaki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/716,700

(22) Filed: Nov. 19, 2003

(30) Foreign Application Priority Data
Nov. 22, 2002 (JP) 2002-338905

(51) Int. Cl. G06F 15/173

(52) U.S. Cl. 709/239; 709/224

(57) ABSTRACT

Backup connection information table 151 having a data of a backup connection included in an alternative route is stored in a storage unit 15 of a network management system 1. On receiving failure occurrence notice of currently-used path, management table operating unit 13 creates based on backup connection information 151 an alternative route management table 153 having a data of backup connection included in the alternative route corresponding to failed currently-used path and registers the alternative route management table 153 in the storage unit 15. On receiving creation notice of a backup connection included in the alternative route, failure recovery determining unit 14 sets a setting status of the backup connection in the alternative route management table 153 to a setting completion and when all the setting status of backup connections included in the alternative route become the setting completion, determines a recovery of failed currently-used path has completed.

### BACKGROUND OF THE INVENTION

1. Field of the Invention

The present invention relates generally to a network management apparatus for managing a transmission network, and more particularly to a network management apparatus for managing an alternative route to be set when a failure has occurred to a currently-used path set in a network.

2. Description of the Related Art

A transmission network having a plurality of nodes (a transmission apparatus, a cross-connecting apparatus, a router, etc.) is provided with a network management apparatus (or a network management system or a network monitoring apparatus) for executing management and maintenance of the transmission network.

As such a network monitoring apparatus as above, conventionally, there is one that, when a failure occurs to a path line between transmission apparatuses on a transmission network, automatically creates a database capable of quickly coping with the failure and maintaining the path line by analyzing alarm information in a message format issued from a transmission apparatus and by identifying the names of the affected path lines, from the location of the transmission apparatus sending the alarm (see Patent Document 1, for example).

On the other hand, a network management apparatus has information representing how the currently-used path for transmitting user signals is set on a transmission network. Then, in the case where a backup route (an alternative route or an alternative path) to be set when a failure has occurred to a link or a node including the currently-used path, is set on a transmission network, the network management apparatus searches for a backup route of the transmission network and relates the currently-used path with the backup route based on the connection information notified of from the node.

For example, FIG. 2 shows an example of a transmission network in which nodes (transmission apparatuses) N1-9 are connected in a meshy pattern by links L1-12. It is assumed that, in this transmission network, a currently-used path P1 including a sub-network connection (SNC) 1 of the node N7/the link L11/the SNC 2/the link L12/the SNC 3 is set.

In the case where a failure (for example, a failure to the link L11) has occurred to this currently-used path, when a backup path B1 including SNC4/the link L8/SNC5/the link L6/SNC6/the link L7/SNC7/the link L10/SNC8 is set, the creation notices of backup connections for SNCs 4-8 are notified of from nodes N7, N4, N5, N6 and N9 in a random order to a network management apparatus. For example, first, in the case where only a creation of the backup connection for SNC6 is notified of to the network management apparatus, the network management apparatus retrieves the connection relationship before and after the SNC6, however, the whole backup path can not be retrieved because creation notices such as those for SNC5 and SNC7 have not been received. Therefore, the network management apparatus stops the retrieval temporarily.

Thereafter, when another backup connection information (for example, for SNC5) has been notified of to the network management apparatus, the network management apparatus again executes the retrieval. When all the backup connection information for SNC4-8 have arrived, the network management apparatus can search for the whole backup path B1 and can relate the backup path B1 to the currently-used path P1.

[Patent Document 1]

Japanese Patent Application Laid-Open (Kokai) Pub. No. 2000-295221 (pp. 2-3)

As described above, in a conventional network management apparatus, the connection relationships of the backup connections are repeatedly retrieved every time creation information for one backup connection has been received and the retrieval is repeated until all the necessary information has been gathered.

### SUMMARY OF THE INVENTION

The object of the invention is to avoid the repetition of the retrieval and to reduce the load of calculation on the network management apparatus.

In order to achieve the above object, a first aspect of the present invention provides a network management apparatus for managing a transmission network in which one (1) or more currently-used route(s) for transmitting signals is/are set, and an alternative route(s) corresponding respectively to the currently-used route(s) and used when a failure(s) has occurred to the currently-used route(s) has/have been defined in advance, and each alternative route is formed by setting backup connections for the alternative route by each node present on the alternative route, comprising a storage unit for storing backup connection information data containing information on backup connections having an alternative route corresponding to each currently-used route, currently-used route data containing information on the currently-used route(s) corresponding to each backup connection and alternative route management data for managing the setting status of the backup connections having the alternative route(s); an operation unit for registering in the storage unit the alternative route management data corresponding to the currently-used route(s) to which the failure(s) has/have occurred, on having received a failure occurrence notice(s) of the currently-used route(s); and a determination unit for identifying the currently-used route(s) corresponding to the backup connections based on the creation notice(s) of the backup connections and the currently-used route data stored in the storage unit on having received from nodes the creation notice(s) of the backup connections, for switching the setting status of the backup connections in the alternative route management data corresponding to the identified currently-used route(s) to completion of the setting and for determining the completion of recovery of the currently-used route(s) when settings of all the backup connections corresponding to the currently-used route(s) to which the failure(s) has/have occurred have been completed.

According to the first aspect of the invention, it is not necessary for a network management apparatus to repeatedly retrieve an alternative route every time a creation notice for a backup connection is received since the backup connection information of alternative routes is registered in alternative route management data. Furthermore, by managing the status of settings for each backup connection in the alternative route management data, it is possible to determine the completion of setting an alternative route, i.e., the completion of the recovery of the ex-currently-used route and the management of the currently-used routes and the alternative routes can be easily carried out. Thereby, the load of calculation on the network management apparatus can be reduced.

According to a second aspect of the present invention there is provided a network management apparatus for managing a transmission network in which, when a failure(s) has/have occurred to a currently-used route(s) set for transmitting signals, each node present on a predetermined alternative route form an alternative route(s) by setting backup connections for the alternative route(s) and the signals are transmitted along the alternative route, comprising a storage unit for storing backup connection data representing the backup connections of each node present on the alternative route(s); an operation unit for creating management data for managing the setting status of the backup connections of said each node based on the backup connection data of said each node stored in the storage unit, on receiving failure occurrence notice(s) of the currently-used route(s); and a determination unit for setting the setting status corresponding to the alternative connections in the management data, to “setting completed” on receiving from a node present on the alternative route a creation notice of the backup connections of the node and for determining that the recovery of the currently-used route(s) has been completed when all the setting statuses of the alternative connections having the alternative route(s) are set to “setting completed”.

The second aspect of the present invention also provides substantially the same function and effect as those of the first aspect.

A third aspect of the present invention provides a network management apparatus for managing a transmission network in which, when a failure(s) has/have occurred to a currently-used route(s) set for transmitting signals, each node present on a predetermined alternative route form an alternative route(s) by setting backup connections for the alternative route(s) and the signals are transmitted along the alternative route, comprising a storage unit for storing management data for managing the setting statuses of the backup connections of each node present on the alternative route(s); and a determination unit for setting the setting status corresponding to the alternative connections in the management data, to “setting completed” on receiving from a node present on the alternative route a creation notice of the backup connections of the node and for determining that the recovery of the currently-used route(s) has been completed when all the setting statuses of the alternative connections having the alternative route(s) are set to “setting completed”.

According to the third aspect of the invention, the same operational advantage as that of the above first aspect can also be obtained.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a block diagram showing the entire composition of the transmission network system having a network management system (network management apparatus) according to an embodiment of the invention;

FIG. 2 shows an example of the detailed composition of a transmission network:

FIG. 3 is a block diagram showing the detailed composition of the network management system;

FIG. 4 shows an example of the backup connection information table;

FIG. 5 shows an example of a currently-used path table;

FIG. 6 shows an example of an alternative route management table;

FIG. 7 is a flow chart showing the flow of the processes of the NMS for the case where it receives path failure information;

FIG. 8 is a flow chart showing the flow of the processes of the NMS for the case where it receives connection creation information;

FIG. 9 shows an example of a creation connection information management table;

FIG. 10 is a flow chart showing the flow of the processes of the NMS in the case where connection creation information is received;

FIG. 11 is a flowchart showing the flow of the processes of the NMS1 when path failure information is received;

FIG. 12 shows two (2) currently-used paths set on the transmission network and their backup connections;

FIG. 13 shows currently-used path table corresponding to the alternative connection information shown in FIG. 12;

FIG. 14 shows an alternative route management table of the two currently-used paths sharing a backup connection;

FIG. 15 shows an example of an overlapping connection information management table;

FIG. 16 is a flow chart showing the flow of the processes of the NMS when it has received the connection creation information containing the process for the overlapping connection information management table;

FIG. 17 shows the status of the transmission network in which a failure has occurred to the two currently-used paths and a backup route is set for the currently-used path having the higher priority;

FIG. 18 shows the status of the transmission network in which the failure occurred to the currently-used path having the higher priority has been recovered; and

FIG. 19 shows the operation of the overlapping connection information management table.

### DESCRIPTION OF THE PREFERRED EMBODIMENT

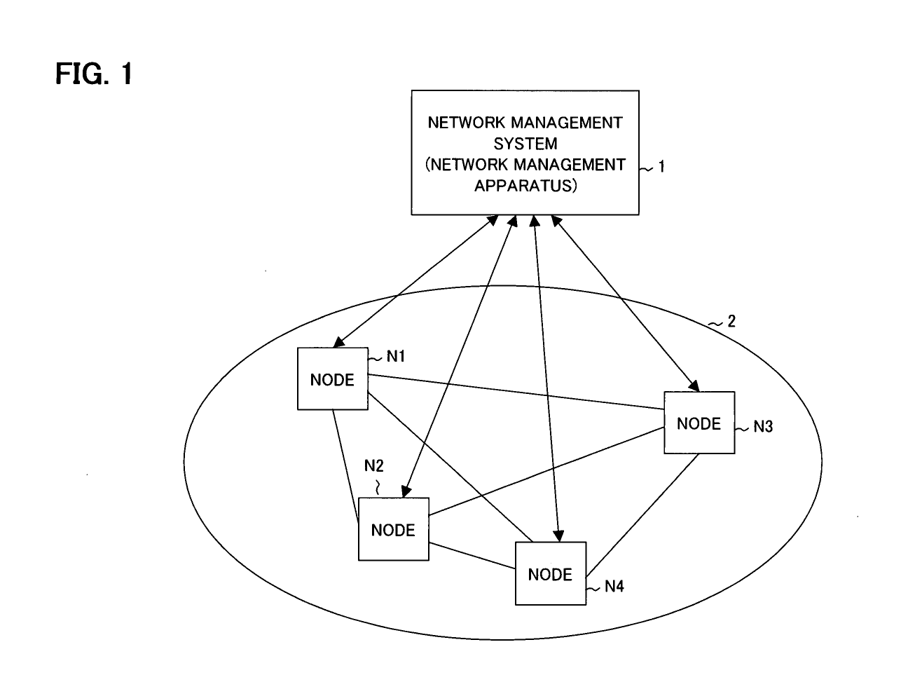

FIG. 1 is a block diagram showing the entire composition of the transmission network system having a network management system (network management apparatus) according to an embodiment of the invention.

This transmission network system has a transmission network 2 having a plurality (for example, four (4) in FIG. 1) of nodes N1-4 for transmitting user signals and control signals, and a network management system (hereinafter, referred to as “NMS”) 1 for managing and maintaining the nodes N1-4 and the transmission network 2. The nodes N1-4 are connected with each other by links (connection links) transmitting the user signals and the control signals. The nodes N1-4 and the NMS 1 are connected by signal lines provided separately from these links.

However, when the scale of a transmission network is large and the number of nodes have been increased, there are NMSs that are structured in layers by dividing the transmission network into a plurality of areas and providing lower-order NMSs for managing and maintaining the areas respectively and a higher-order NMS for controlling over these lower-order NMSs. The network management apparatus according to the invention can also be applied to these lower-order NMSs and the higher-order NMSs (or middle-order NMSs installed between the lower-order NMSs and the higher-order NMSs).

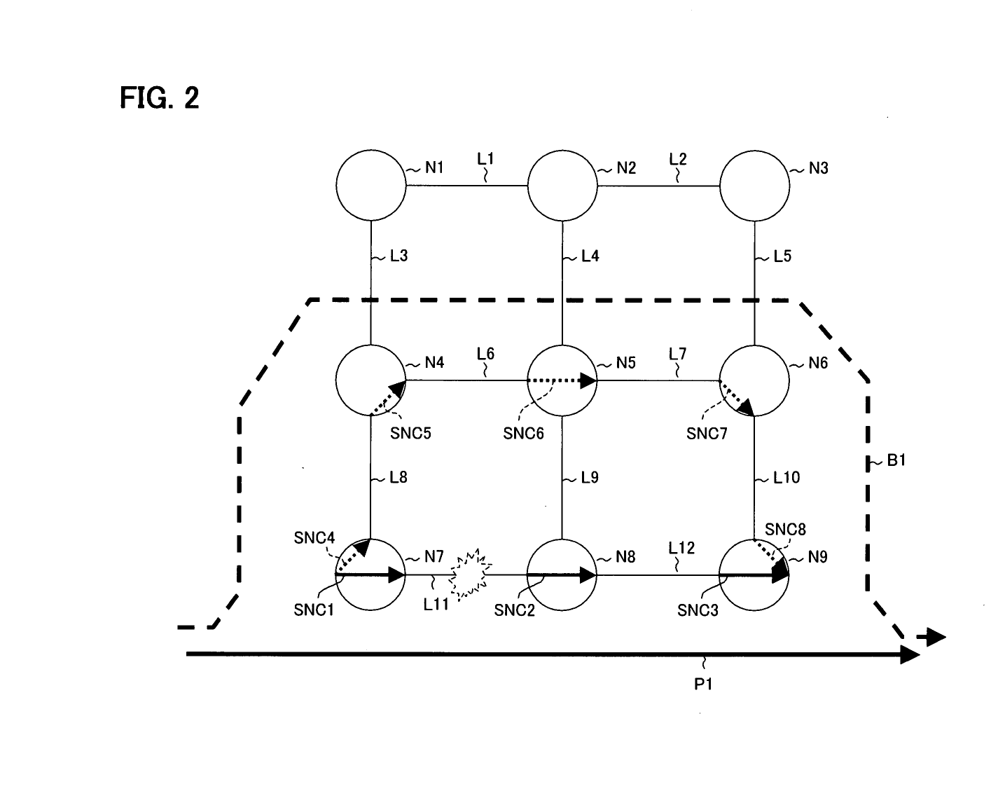

FIG. 2 is a block diagram showing an example of a detailed composition of a transmission network 2. The transmission network 2 shown in this figure has nodes N1-9. These nodes N1-9 are connected, for example, in a meshy pattern by links L1-12. The nodes N1-9 are, for example, cross-connecting apparatuses and/or routers etc.

A path (route) for transmitting user signals is set on the transmission network 2. In FIG. 2, as an example, a path P1 passing the nodes N7/N8/N9 is set. Paths are classified into “currently-used paths (currently-used routes)” to be set and used when no failure is occurring to the paths and “backup routes (backup paths or alternative routes)” to be set and used instead of the currently-used paths when failures have occurred to the currently-used paths. In FIG. 2, a backup route B1 is indicated by the dotted line, that passes the nodes N7/N4/N5/N6/N9 and is used instead of the currently-used path P1 when a failure has occurred to the link L11 included in the currently-used path P1.

In each node, connections for setting a path are formed and each node holds this connection information. This connection information is sub-network connection (hereinafter, referred to as “SNC”) information or cross-connection information for a transmission network and is routing information for an MPLS (Multi-protocol Label Switching) network. Hereinafter, a connection will be represented by an SNC and connection information will be represented by SNC information.

For example, in the node N7, an SNC 1 for connecting an input terminal (input port) for user signals and an output terminal (output port) to the link L11 is formed and, in the node N8, an SNC 2 for connecting an input terminal from the link L11 and an output terminal to the link 12 is formed. The input terminal and the output terminal are referred to as “CTP (Connection Termination Point)”. An SNC represents a connection relationship of a CTP on the input side and a CTP on the output side.

When a failure has occurred to a link or a node, a node connected downstream adjacent to the link to which the failure has occurred transmits to all the other nodes failure occurrence information having information indicating the link or the node to which the failure has occurred (for example, a link identifier of the link to which the failure has occurred). For example, as shown in FIG. 2, when a failure has occurred to the link L11, the node N8 transmits failure occurrence information to other nodes. Thereby, all the nodes can know which link the failure has occurred to. The failure occurrence information can also be transmitted using a control signal and can also be transmitted being inserted in the header of a user signal.

When a failure has occurred, a node located most downstream in the currently-used path notifies the network management system 1 of “path failure information” containing information indicating the path to which the failure has occurred (for example, path identifier). For example, when a failure has occurred to the link L11, the node N9 notifies the network management system of path failure information containing the path identifier of the currently-used path P1.

Each node executes autonomously processes for setting a backup route. More specifically, when the failure has occurred, each node has held in advance SNC information for a backup route correlated to the link to which the failure has occurred and sets an SNC autonomously based on this SNC information. For example, the nodes N7, N4, N5, N6 and N9 having received the failure occurrence information for the link L11 respectively has held in advance information of SNC 4, SNC 5, SNC 6, SNC 7 and SNC 8 indicated by the dotted lines in FIG. 2, correlating to the link L11, and sets the SNC based on the information. A backup route B1 is set according to the setting of these SNCs. When each node has set an SNC, it notifies the NMS1 of the information of the SNC it has set.

The NMS1 searches for a backup route based on the path failure information and the SNC information that it has received. Hereinafter, a detailed composition and processes of the NMS1 will be described.

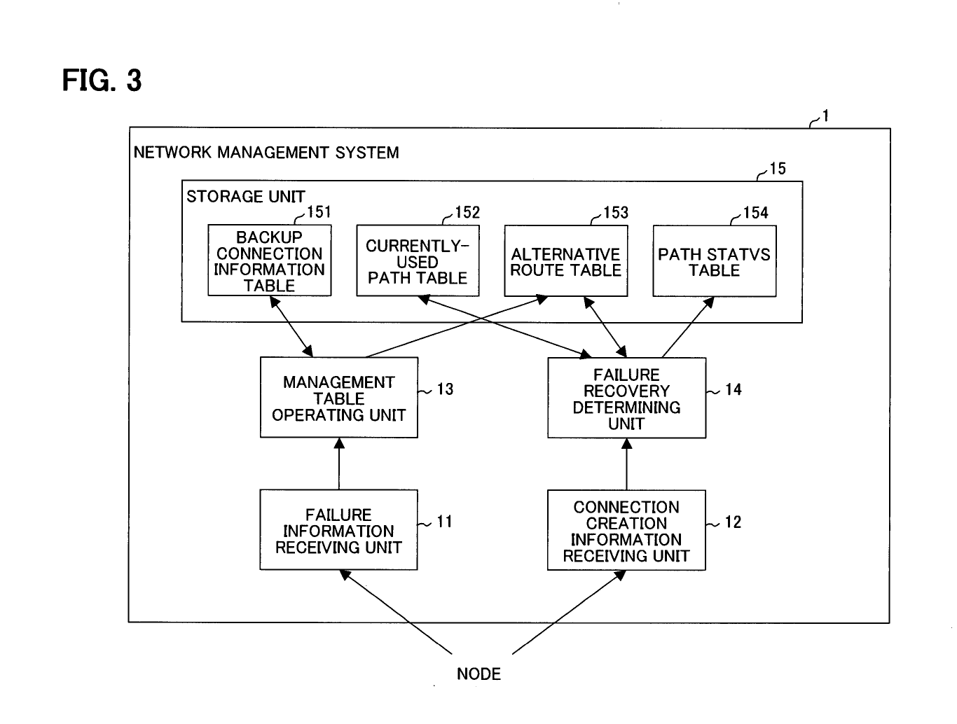

FIG. 3 is a block diagram showing the detailed composition of the NMS1. The NMS1 has a failure information receiving unit 11, a connection creation information receiving unit 12, a management table operating unit 13, a failure recovery determining unit 14 and a storage unit 15. In the storage unit 15, a backup connection information table 151, a currently-used path table 152, an alternative route (backup route) table 153 and a path status table 154 are stored.

The backup connection information table 151 is a table in which currently-used paths, and backup connection information to be set when a failure has occurred to any of the currently-used paths are correlated, and is stored in the storage unit 15 in advance.

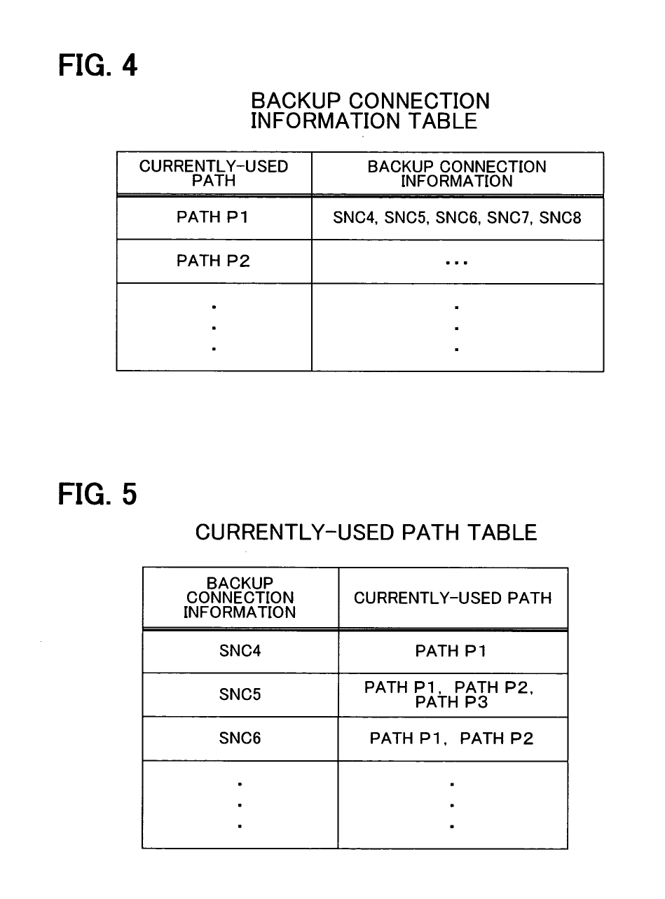

FIG. 4 shows an example of the backup connection information table 151. The backup connection information table has path identifiers of the currently-used paths set on the transmission network 2 (such as the path P1 and the path P2) and information of backup connections to be set when a failure has occurred to each currently-used path (in this case, information of SNCs included in backup routes (such as SNC4 and SNC5)). For example, as the backup connection information for the case where a failure has occurred to the currently-used path P1, SNC4, SNC5, SNC6, SNC7 and SNC8 are provided. In the case where another currently-used path (for example, the currently-used path P2) is set, the backup connection information is also provided.

The currently-used path table 152 is a table in which backup connection information, and currently-used path information indicating for which currently-used path a backup connection of the backup connection information is set when a failure has occurred to the currently-used path are correlated, and is stored in the storage unit 15 in advance.

FIG. 5 shows an example of the currently-used path table 152. The currently-used path table has backup connection information (SNC information) and the path identifier of the currently-used path corresponding to the backup connection information. For example, the SNC4 is set when a failure has occurred to the path P1 and the SNC5 is set when failures have occurred to the paths P1, P2 and P3.

The alternative route management table 153 is a table in which a currently-used path, backup connection information for the case where a failure has occurred to the currently-used path and the setting status of the backup connection are correlated, and the table 153 is created by the management table operation unit 13 for managing recovery status of a path when a failure has occurred to the currently-used path, and is stored in the storage unit 15.

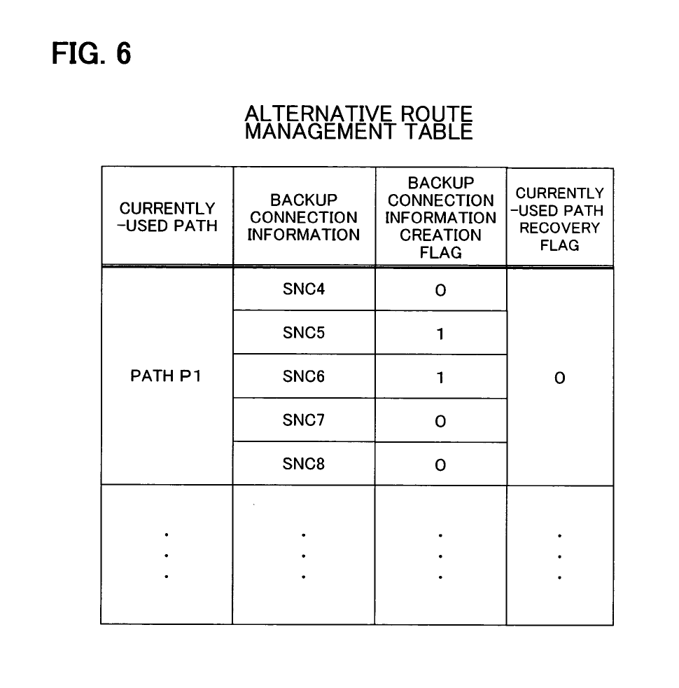

FIG. 6 shows an example of the alternative route management table 153. The alternative route management table has path identifier of the currently-used path, backup connection information for the currently-used path (SNC information), a backup connection information creation flag and a currently-used path recovery flag. The “backup connection information creation flag” is a flag indicating whether or not the setting of the backup connection has been completed by a node and its initial value is set at zero (0) and it is set at one (1) when the backup connection has been set by the node. The “currently-used path recovery flag” is a flag indicating whether or not the setting of a backup route for the currently-used path (i.e., the setting of all the backup connections included in the backup route) has been completed and it is set at zero (0) as the initial value and is set at one (1) when all the backup connection information creation flags have been set at one (1).

The path status table 154 holds the recovery status of the path and is set by the failure recovery determination unit 14.

The failure information receiving unit 11 receives path failure information from a node and sends the received path failure information to the management table operating unit 13. The management table operation unit 13 extracts (reads out) from the backup connection information table 151 backup connection information for a path to which a failure has occurred designated by the path failure information, creates an alternative route management table based on the extracted backup connection information and stores the created table in the storage unit 15.

The connection creation information receiving unit 12 receives from the node the connection information (backup connection information, backup connection creation information and connection creation information) set by the node when the failure is recovered and sends the received connection information to the failure recovery determination unit 14.

The failure recovery determination unit 14, in the alternative route management table 153, sets the backup connection information creation flag corresponding to the connection creation information given by the connection creation information receiving unit 12, to one (1) and, at the same time, sets the currently-used path recovery flag to one (1) if all the backup connection information creation flags are set to one (1) and, further, determines whether the recovery of the currently-used path has been completed or uncompleted based on the value (1/0) of the currently-used path recovery flag.

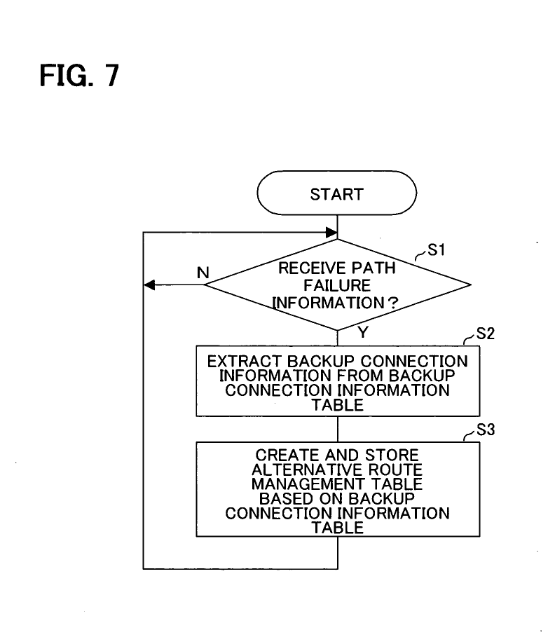

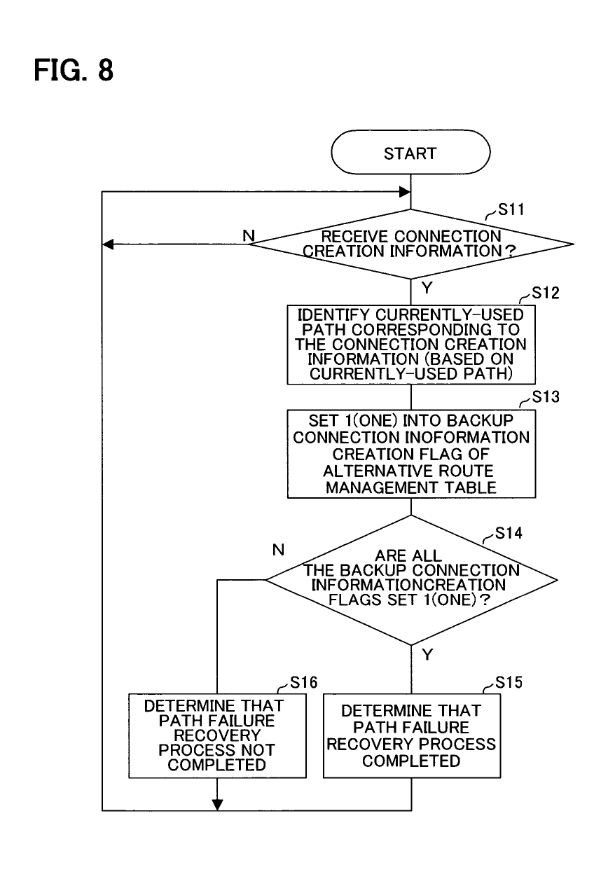

FIG. 7 is a flowchart showing the flow of the processes of the NMS1 for the case where it receives the path failure information. FIG. 8 is a flow chart showing the flow of the processes of the NMS1 for the case where it receives the connection creation information.

When a failure has occurred to, for example, the link L11 on the route of the currently-used path P1, the node N9 located at the downstream end of the currently-used path P1 detects the failure on the currently-used path P1 and notifies the NMS1 of the path failure information.

Referring to FIG. 7, the failure information receiving unit 11 of the NMS1 is in a state for waiting for the path failure information from the node (S1) and, when it has received the path failure information (Y of S1), it sends the received path failure information to the management table operation unit 13.

The management table operation unit 13 extracts from the backup connection information table 151 the backup connection information corresponding to the path identifier contained in the path failure information (S2), creates the alternative route management table 153 corresponding to the path with the failure based on the extracted backup connection information and stores it in the storage unit 15 (S3). During this, the management table operation unit 13 initializes both the backup connection information creation flag and the currently-used path recovery flag in the alternative route management table it has created, to zero (0).

For example, when the path failure information of the currently-used path P1 is received, the management table operation unit 13 creates the alternative route management table 153 (see FIG. 6) of the path P1 based on the backup connection information (see FIG. 4) of the path P1 of the backup connection information table 151, initializes both the backup connection information creation flag and the currently-used path flag to zero (0) and stores the created table in the storage unit 15.

On the other hand, the node N8 notifies other nodes of the failure occurrence information of the link L11. The nodes N7, N4, N5, N6 and N9 located on the backup route B1 set SNCs as the failure recovery process based on this failure occurrence information and notifies the NMS1 of the connection creation information of the SNC it has set (SNC information)

Referring to FIG. 8, the connection creation information receiving unit 12 of the NMS1 is in a status for waiting for the connection creation information (SNC information) from the nodes (S11) and, when it receives the connection creation information (Y of S11), it sends the received connection creation information to the failure recovery determination unit 14.

The failure recovery determination unit 14 identifies the currently-used path identifier corresponding to the connection creation information based on the currently-used path table 152 (see FIG. 5) and the connection creation information (SNC information) stored in the storage unit 15 (S12). Subsequently, the failure recovery determination unit 14, at the alternative route management table corresponding to the currently-used path identifier having been identified, sets the backup connection information creation flag corresponding to the connection creation information to one (1) (S13).

For example, when the failure recovery determination unit 14 has received the connection creation information of the SNC6, it identifies the path P1 and P2 based on the currently-used path table. In this case, the alternative route management table for the path P1 has been created, however, the alternative route management table for the path P2 has not been created. Therefore, the failure recovery determination unit 14 sets the alternative connection information creation flag corresponding to the SNC6 of the alternative route management table for the path P1 to one (1).

Then, the failure recovery determination unit 14 determines whether or not all the backup connection information creation flags are set to one (1) (S14). When all the backup connection information creation flags are set to one (1) (Y of S14), the failure recovery determination unit 14 determines that the setting of the alternative route corresponding to the currently-used path has been completed and the path failure recovery process has been completed, sets the currently-used path recovery flag to one (1) and as well as registers in the path status table 154 the completion of the failure recovery of the currently-used path P1 (S15).

On the other hand, in the case where not all the backup connection information creation flags are set to one (1) (N of S14), the failure recovery determination unit 14 determines that the setting for the alternative route has not been completed and, the path failure recovery processes have not been completed. Thereafter, the processes from Step S11 are repeated.

As described above, according to the embodiment, it is possible to obtain a backup route without retrieving the backup routes repeatedly and to grab the setting status of the backup route. Therefore, the load of calculation on the NMS1 can be reduced.

Though it has been described that the management table operation unit 13 creates the alternative route management table 153 and the created table is stored in the storage unit 15 in Step S3, the alternative route management table 153 may be created in advance being correlated to each alternative route and may be stored in advance in the storage unit 15.

Next, the processes for the case where, when a failure has occurred, before the path failure information is notified of to the NMS1, the connection creation information has been notified of to the NMS1.

For example, there is a case where, when a failure has occurred to the path P1 in FIG. 2, before the path failure information of the path P1 has been notified of from the node N9 to the NMS1, the connection creation information for the SNC5 and the SNC6 is notified of to the NMS1. In such a case, the alternative route management table 153 of the path to which the failure has occurred is not stored in the storage unit 15.

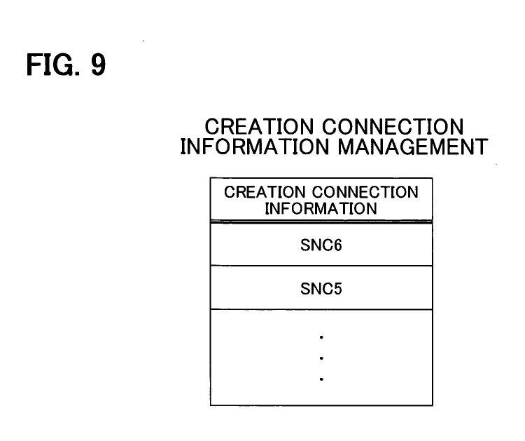

Therefore, in this case, the failure recovery determination unit 14 creates the creation connection management table shown in FIG. 9 (not shown in FIG. 3) and stores it in the storage unit 15. Thereafter, the path failure information has been received and the alternative route management table has been created. Then, the failure recovery determination unit 14 extracts connection information from creation connection information management table and sets to one (1) the corresponding backup connection information creation flag on the alternative route management table.

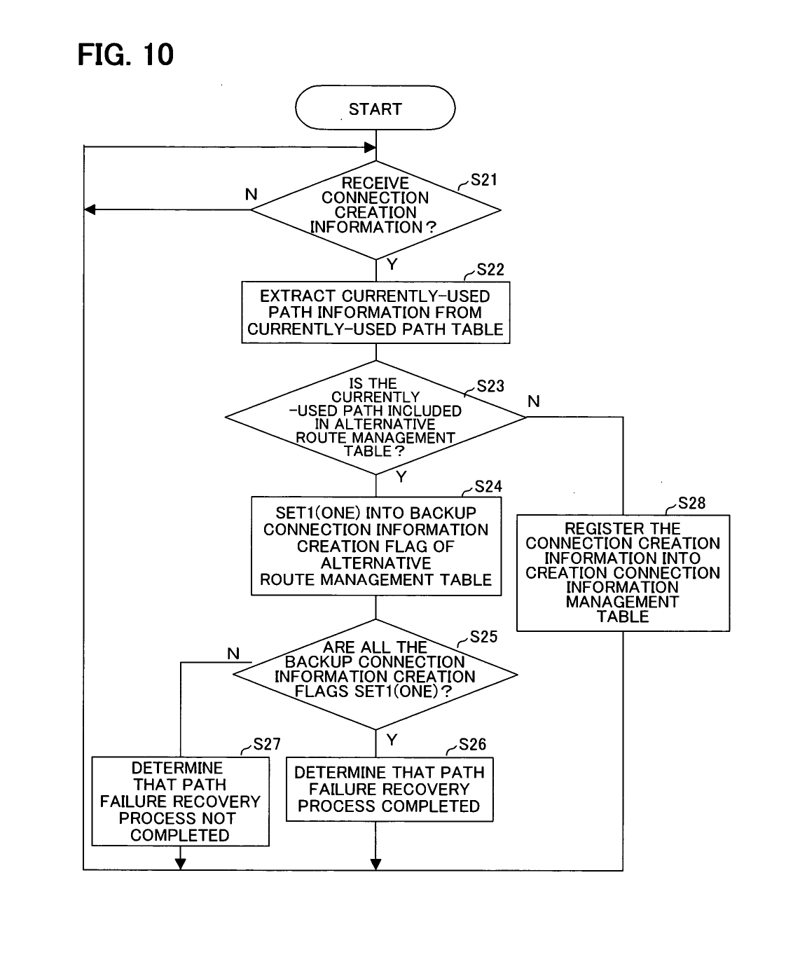

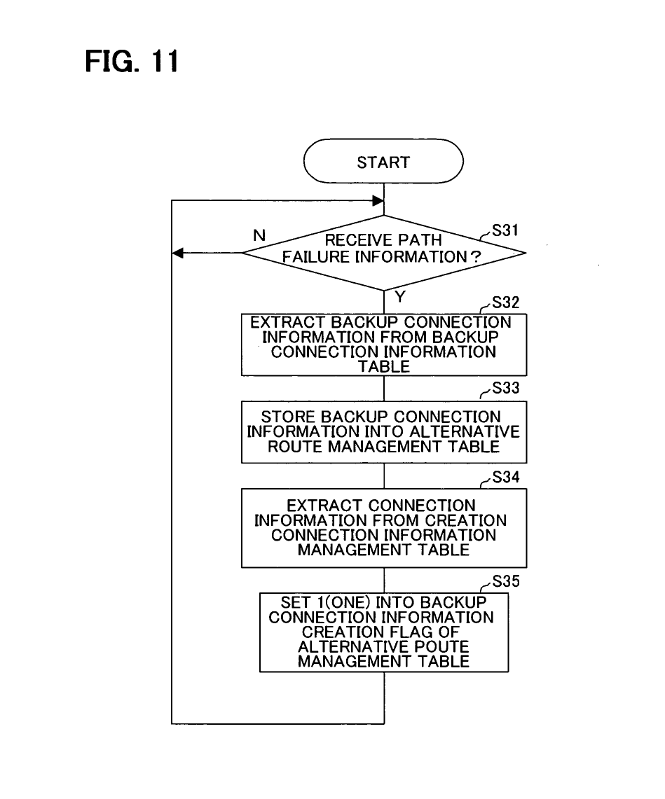

FIG. 10 is a flow chart showing the flow of the processes of the NMS1 when the connection creation information is received. FIG. 11 is a flow chart showing the flow of the processes of the NMS1 when the path failure information is received.

Referring to FIG. 10, when the connection creation information receiving unit 12 of the NMS1 has received the connection creation information (SNC information) (Y of S21), it sends the received connection creation information to the failure recovery determination unit 14. The failure recovery determination unit 14 extracts a currently-used path identifier corresponding to the connection creation information from the currently-used path table 152 (S22) and determines whether or not the alternative route management table 153 corresponding to the extracted currently-used path identifier is stored in the storage unit 15 (S23).

In the case where the alternative route management table 153 corresponding to the extracted currently-used path identifier is not stored in the storage unit 15 (N of S23), the failure recovery determination unit 14 registers the connection creation information into the creation connection information management table (S28) and returns to the status for waiting for receiving (S21).

On the other hand, in the case where the alternative route management table corresponding to the extracted currently-used path identifier is stored in the storage unit 15 (Y of S23), the failure recovery determination unit 14 sets the backup connection information creation flag corresponding to the received connection creation information, in the alternative route management table, to one (1) (S24).

Thereafter, the failure recovery determination unit 14 determines whether or not all of the backup connection information creation flags are set to one (1) (S25). When all of them are set to one (1) (Y of A25), it sets the currently-used path recovery flag to one (1) and determines that the path failure recovery has been completed (S26). When not all of them are set to one (1) (N of S25), it determines that the path failure recovery has not been completed (S27).

Referring to FIG. 11, when the failure information receiving unit 11 has received the path failure information (Y of S31), it sends the received path failure information to the management table operation unit 13. The management table operation unit 13 extracts from the backup connection information table 151 the backup connection information corresponding to the path identifier contained in the path failure information (S32), creates an alternative route management table based on the extracted backup connection information and stores it in the storage unit 15 (S33).

Then, when the creation connection information management table created by the failure recovery determination unit 14 is stored in the storage unit 15, the management table operation unit 13 extracts the connection information from the table (S34) and sets the backup connection information creation flag corresponding to the extracted connection information to one (1) (S35). Subsequently, the process returns to step S31.

In this manner, even in the case where the connection creation information has been received by the NMS1 earlier than the path failure information does, it is possible to obtain the backup route and the setting status of the backup route without repeating the retrieval and to reduce the process load on the NMS1.

Next, the recovery management of the currently-used path by the NMS1 for the case where the SNC having the backup route is shared by a plurality of currently-used paths will be described.

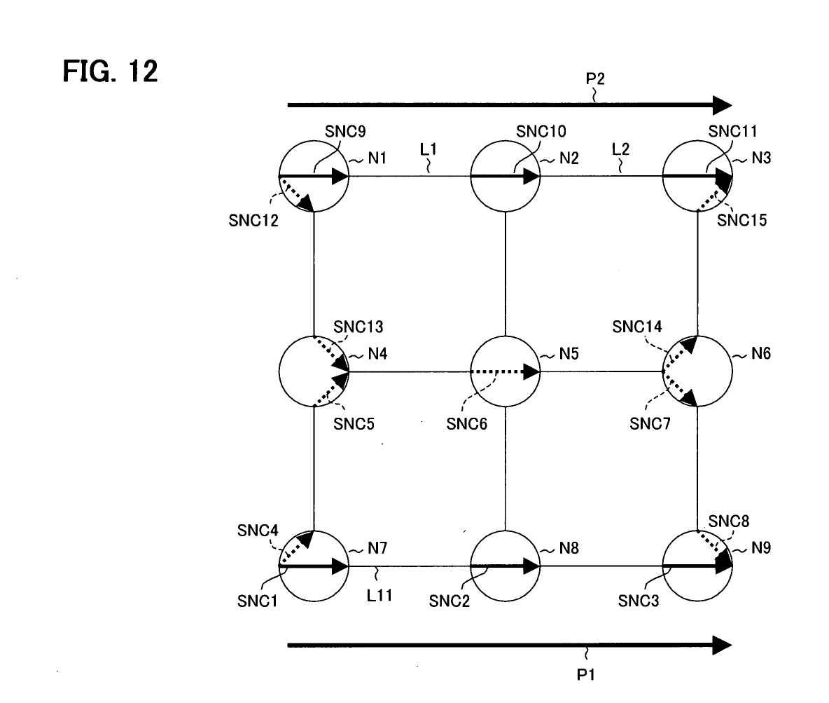

There is a case where the SNC having the backup route is shared by a plurality of currently-used paths. For example, as shown in FIG. 12, in the case where there are paths such as the path P1 passing the SNC1, the SNC2 and the SNC3, and the path P2 passing the SNC9, the SNC10 and the SNC11, and backup connection information SNC4, SNC5, SNC6, SNC7 and SNC8 is predetermined for the path P1 and backup connection information SNC12, SNC13, SNC6, SNC14 and SNC15 is predetermined for the path P2, the SNC6 is shared by the currently-used paths P1 and P2.

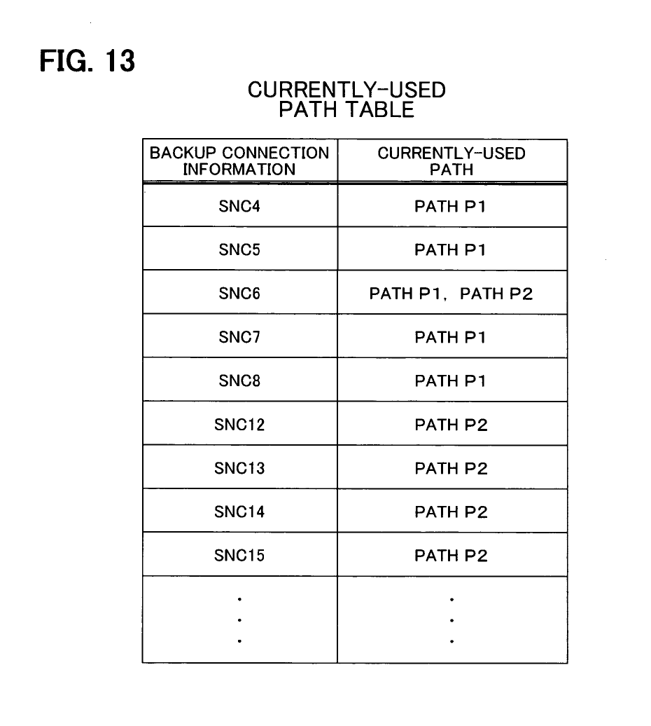

FIG. 13 shows the currently-used path table corresponding to the backup connection information in FIG. 12. It is shown in the figure that the SNC6 supports the currently-used paths P1 and P2 and the SNC6 is shared by the two (2) currently-used path.

It is assumed that, in this case, when failures have occurred to the path P1 and P2 at the same time (for example, when failures have occurred to the link L11 of the path P1 and the link L1 of the path P2), the paths are recovered in the order starting from the path having the highest priority through the communication between nodes. In the example shown in FIG. 12, the priority of the path P1 is higher than that of P2 and a backup route for the path P1 is given the priority in setting.

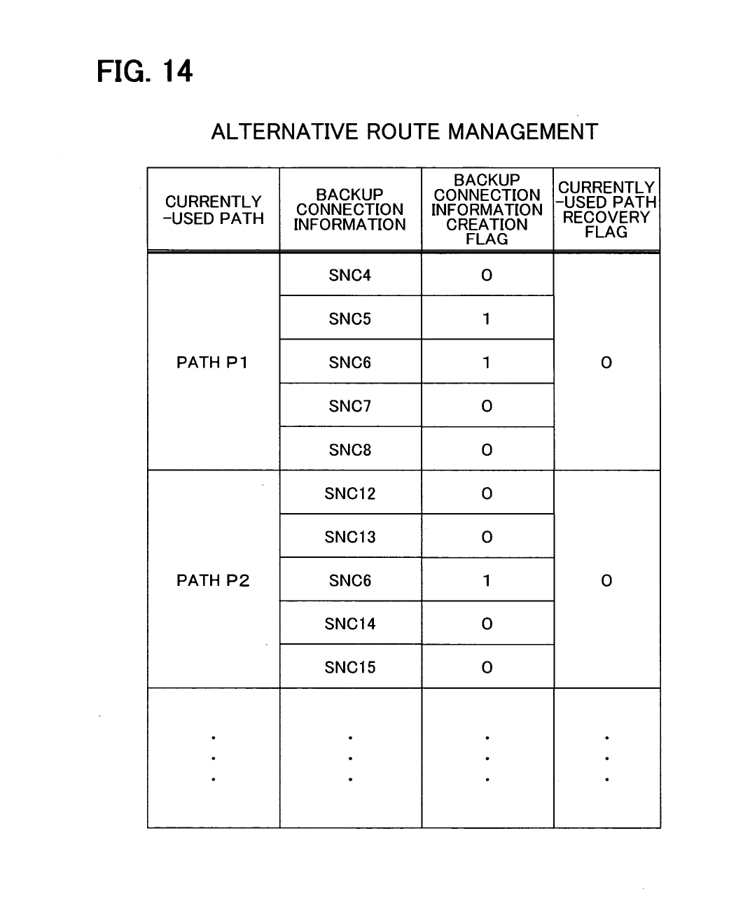

Under the status where path failure information for the paths P1 and P2 has been notified of to the NMS1 and connection creation information for the SNC5 and the SNC6 has been notified of to the NMS1, the alternative route management table 153 becomes as shown in FIG. 14.

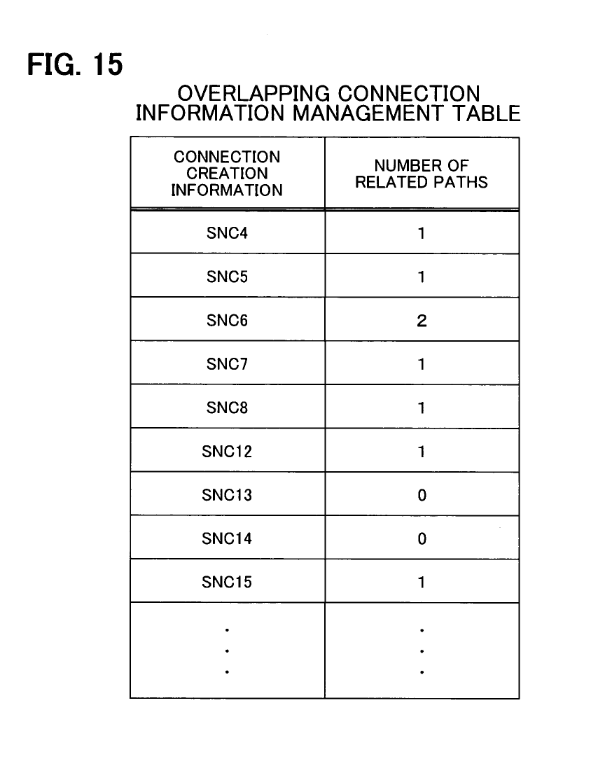

Then, in order to facilitate the backup connection management of NMS1 in the case where one (1) backup connection is shared by a plurality of currently-used paths, the storage unit 15 is newly provided with an overlapping connection information management table (not shown in FIG. 3) for managing the backup connection information related to the recovery of the plurality of paths. FIG. 15 shows an example of the overlapping connection information management table. The overlapping connection information management table has connection information (backup connection information) and the number of the relevant paths for the connection information.

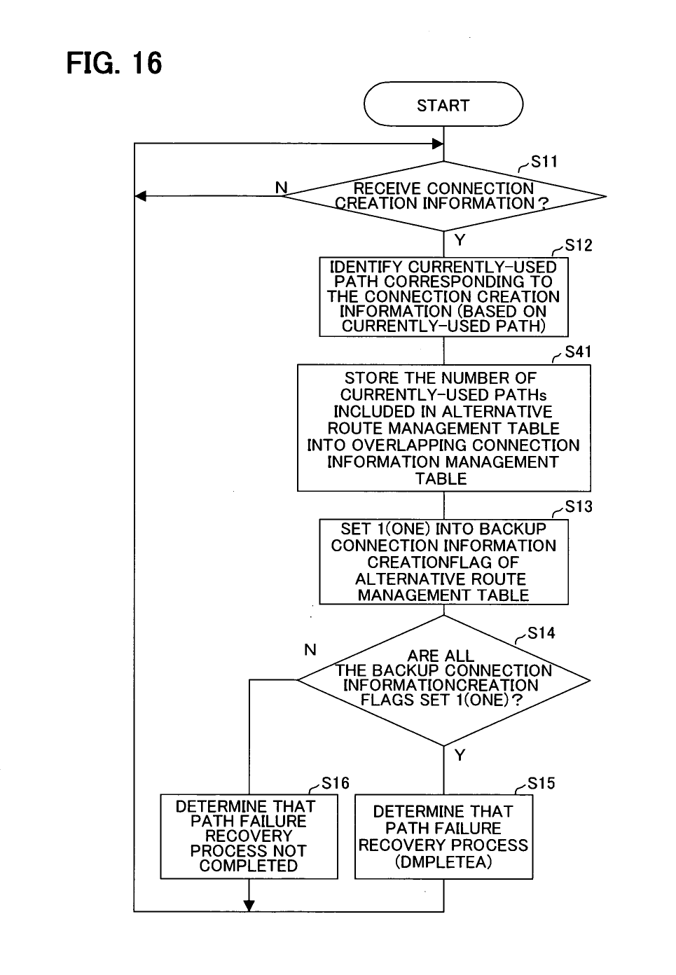

FIG. 16 is a flow chart showing the flow of the processes of the NMS1 when it has received the connection creation information containing the process for the overlapping connection information management table. The same references are given to the same processes as in the FIG. 10 and the description for them will be omitted. Being clear from FIG. 16, the flowchart shown in FIG. 16 is almost same as that shown in FIG. 10 and the only difference is that a process, Step S41 is added between Step S12 and Step S13 in FIG. 16.

In Step S41, the failure recovery determination unit 14 counts the number of the currently-used paths corresponding to the received connection creation information based on the alternative route management table and stores the number in the overlapping connection information management table.

For example, when the received connection creation information is for the SNC6, the alternative route management tables having the SNC6 are two (2) such as the ones for the currently-used path P1 and P2, and the count value is two (2) since the currently-used path recovery flag is set to zero (0). Therefore, “two (2)” is set in the column for the number of the relevant paths for SNC6 in the overlapping connection information management table. On the other hand, when the received connection creation information is for the SNC5, the SNC5 is related to the currently-used path P1 and the currently-used recovery flag is set to zero (0) since the path P1 is registered in the alternative route management table. Therefore, the number of the relevant paths on the overlapping connection information management table is set to “one (1)”.

Next, the processes of the NMS1 for the overlapping connection information management table for the case where the currently-used path to which the failure has occurred has been recovered.

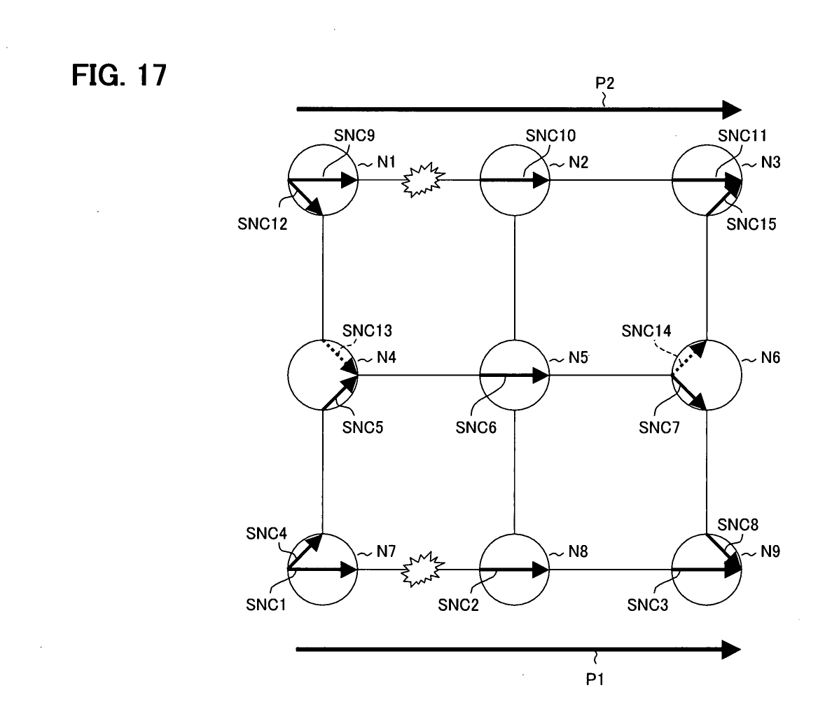

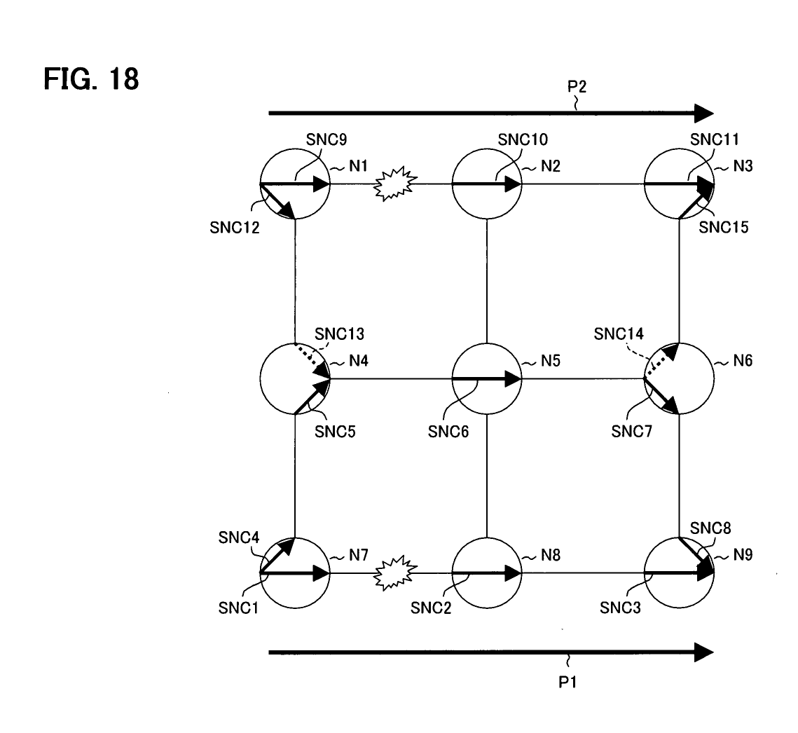

FIG. 17 shows the status of the transmission network 2 in which failures have occurred to the currently-used paths P1 and P2 and a backup route is set for the currently-used path P1 having the higher priority. FIG. 18 shows the status of the transmission network 2 in which the failure-occurred to the currently-used path P1 shown in FIG. 17 has been recovered.

As shown in FIG. 18, when the failure on the link L11 on the path P1 has been recovered, the recovery of the failure on the link L11 is notified of to the NMS1. Thereby, the NMS1 instructs the nodes N4-9 related to the currently-used path P1 and its backup route B1 to switch back from the backup route B1 to the currently-used path P1.

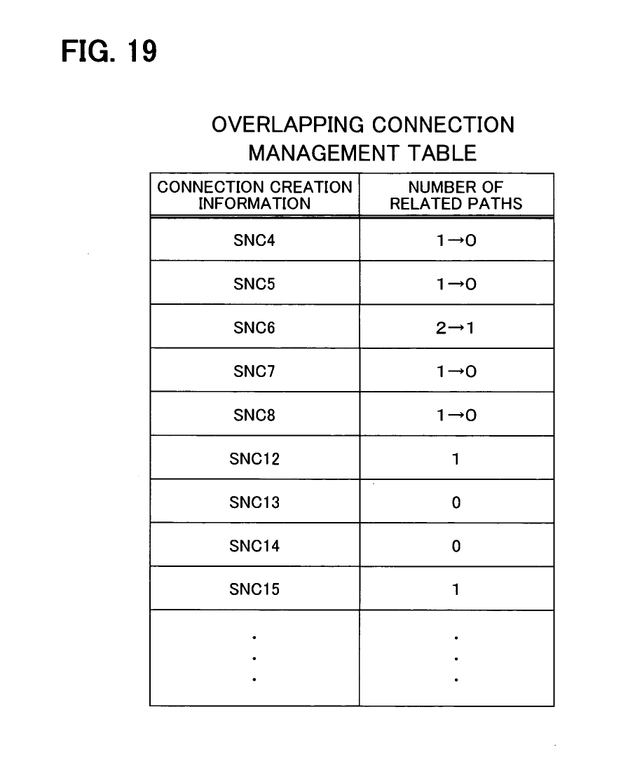

At this moment, as shown in FIG. 19, the failure recovery determination unit 14 reduces by one (1) the number of the relevant paths for the SNC4, SNC5, SNC6, SNC7 and SNC8 included in the backup route of the path P1 in the overlapping connection information management table.

By these processes, in response to the connection information for which the number of the relevant paths has become zero (0), the failure recovery determination unit 14 gives an instruction to the nodes to release the connection relating to the connection information, and does not give, in response to the connection information for which the number of the relevant paths has become one (1) or more, an instruction to the nodes to release the connection relating to the connection information. In the example shown in FIG. 19, instructions for releasing the connections of SNC4, SNC5 etc. are given respectively to the nodes N7, N4 etc. while an instruction for releasing the connection of the SNC6 is not given to the node N5. Then, the SNC6 is kept being used for the backup route for the currently-used path P2.

As described above, by managing a backup connection shared by a plurality of currently-used paths, by an overlapping connection information management table, it is possible to give instructions for releasing connections to the connections used by the backup route of another currently-used path when switching back. As a result, it is possible to recover the path P2 quickly by reducing excessive release processes.

According to the invention, it is possible to easily obtain the corresponding relation of the backup connection information created when a failure has occurred and the currently-used paths, and the calculation load can be reduced.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A network management apparatus for managing a transmission network in which one (1) or more currently-used route(s) for transmitting signals is/are set, and an alternative route(s) corresponding respectively to the currently-used route(s) and used when a failure(s) has occurred to the currently-used route(s) has/have been defined in advance, and each alternative route is formed by backup connections for the alternative route being set by each node present on the alternative route, comprising:
a storage unit storing backup connection information data containing information on the backup connections comprising the alternative route corresponding to each currently-used route, currently-used route data containing information on the currently-used route(s) corresponding to each backup connection and alternative route management data for managing setting status of the backup connections comprising the alternative route(s);
an operation unit registering in the storage unit the alternative route management data corresponding to the currently-used route(s) to which a failure(s) has/have occurred, on having received a failure occurrence notice(s) of the currently-used route(s); and
a determination unit identifying the currently-used route(s) corresponding to the backup connections based on a creation notice(s) of the backup connections and the currently-used route data stored in the storage unit, on having received from nodes the creation notice(s) of the backup connections, switching the setting status of the backup connections in the alternative route management data corresponding to the identified currently-used route(s) to a setting completion and determining a recovery completion of the currently-used route(s) when the setting status of all the backup connections corresponding to the currently-used route(s) to which the failure(s) has/have occurred become the setting completion.

2. The network management apparatus according to claim 1, wherein the alternative route management data contains data representing recovery status of the corresponding currently-used route(s) and the determination unit determines the recovery completion of the currently-used route(s) by setting the data representing the recovery status to “recovered” when all the setting status of the backup connections corresponding to the currently-used route(s) to which the failure(s) has/have occurred become the setting completion.

3. The network management apparatus according to claim 1, wherein:
the storage unit further stores creation connection information management data in which the backup connections having notified of from the nodes is registered;
the determination unit, on having received the creation notice(s) of the backup connections, when the alternative route management data of the currently-used route(s) corresponding to the creation notice(s) of the backup connections is not registered in the storage unit, registers the backup connections of the received creation notice(s), in the creation connection information management data;
the operation unit, on having received the failure occurrence notice(s) of the currently-used route(s), registers the alternative route management data corresponding to the currently-used route(s) to which the failure(s) has/have occurred, in the storage unit and sets the setting status of the backup connections same as the backup connections registered in the creation connection information management data to the setting completion among the setting statuses of backup connections of the registered alternative route management data.

4. The network management apparatus according to claim 2, wherein:
the storage unit further stores creation connection information management data in which the backup connections having notified of from the nodes is registered;
the determination unit, on having received the creation notice(s) of the backup connections, when the alternative route management data of the currently-used route(s) corresponding to the creation notice(s) of the backup connections is not registered in the storage unit, registers the backup connections of the received creation notice(s), in the creation connection information management data;
the operation unit, on having received the failure occurrence notice(s) of the currently-used route(s), registers the alternative route management data corresponding to the currently-used route(s) to which the failure(s) has/have occurred, in the storage unit and sets the setting status of the backup connections same as the backup connections registered in the creation connection information management data to the setting completion among the setting statuses of backup connections of the registered alternative route management data.

5. The network management apparatus according to claim 2, wherein:
the storage unit further stores overlapping connection management data representing the number of the currently-used route(s) corresponding to each backup connection;
the determination unit, on receiving the creation notice of the backup connections from the nodes, identifies the currently-used route(s) corresponding to the backup connections of the creation notice(s) based on the currently-used route data and registers in the overlapping connection management data the number of the currently-used route(s) which registered in the alternative route management data and data representing which recovery status is/are not set to “recovered”.

6. The network management apparatus according to claim 5, wherein the determination unit, when switching back from the alternative route(s) to the currently-used route(s), identifies the backup connections corresponding to the alternative route(s) based on the backup connection information data, reduces by one (1) the number of the identified backup connections in the overlapping connection management data, and releases the backup connections of which the number has become zero (0).

7. A network management apparatus for managing a transmission network in which, when a failure(s) has/have occurred to a currently-used route(s) set for transmitting signals, each node present on a predetermined alternative route form an alternative route(s) by setting backup connections for the alternative route(s) and the signals are transmitted along the alternative route, comprising:
a storage unit for storing backup connection data representing the backup connections of the each node present on the alternative route(s);
an operation unit for creating management data for managing a setting status of the backup connections of said each node based on the backup connection data of said each node stored in the storage unit, on receiving failure occurrence notice(s) of the currently-used route(s); and
a determination unit for setting the setting status corresponding to the backup connections in the management data, to a setting completion on receiving from the node present on the alternative route a creation notice of the backup connections of the node and for determining that a recovery of the currently-used route(s) has been completed when all the setting statuses of the alternative connections included in the alternative route(s) are set to the setting completion.

8. A network management apparatus for managing a transmission network in which, when a failure(s) has/have occurred to a currently-used route(s) set for transmitting signals, each node present on a predetermined alternative route form an alternative route(s) by setting backup connections for the alternative route(s) and the signals are transmitted along the alternative route, comprising:
a storage unit for storing management data for managing a setting status of the backup connections of the each node present on the alternative route(s); and
a determination unit for setting the setting status corresponding to the alternative connections in the management data, to a setting completion on receiving from a node present on the alternative route a creation notice of the backup connections of the node and for determining that the recovery of the currently-used route(s) has been completed when all the setting statuses of the alternative connections included in the alternative route(s) are set to the setting completion.
